(19) United States
(12) Patent Application Publication
(10) Pub. No.: US 2004/0177728 A1
(43) Pub. Date: Sep. 16, 2004

(54) Y-wrench for engagement with spokes of wheels of sizes

(76) Inventor: Cherng-Bin Hwang, Chia Yi Hsien (TW)

Correspondence Address: Alan D. Kamrath, NIKOLAI 7 MERSEREAU, P.A.,, 820 INTERNATIONAL CENTRE, 900 SECOND AVENUE SOUTH, Minneapolis, MN, 55402, US

(21) Appl. No.: 10/385,943

(22) Filed: Mar. 10, 2003

(51) Int. Cl. B25B 13/10

(52) U.S. Cl. 81/176.3

(57) ABSTRACT

A Y-wrench is provided for a wheel with several spokes. The Y-wrench includes a handle, a first prong extending from the handle, a second prong pivotally connected with the handle, a first rod connected with the first prong and a second rod connected with the second prong. In operation, the first rod is engaged with one of the spokes and the second rod is engaged with another one of the spokes. Thus, the wheel is kept in position with the Y-wrench. A spring may be provided between the first prong and the second prong.

### BACKGROUND OF THE INVENTION

1. Field of Invention

The present invention relates to a Y-wrench for engagement with spokes of wheels of various sizes.

2. Related Prior Art

Referring to FIG. 8, a wheel 4 includes a hub and four spokes extending from the hub. A bolt 6 is inserted through the hub. A wrench 7 is used to drive the bolt 6. To prevent the wheel 4 from rotation while driving the bolt 6 with the wrench 7, a Y-wrench 1 is used for engagement with the spokes. The Y-wrench I includes a handle and two prongs 2 extending from the handle. From each of the prongs 2 extends a rod 3. In operation, each of the rods 3 is engaged with one of the spokes. However, the rods 3 are at a constant distance from each other. Therefore, to engage with the spokes of a wheel of a different size, a Y-wrench of a different size must be provided, and this is inconvenient.

The present invention is therefore intended to obviate or at least alleviate the problems encountered in prior art.

### SUMMARY OF THE INVENTION

It is the primary objective of the present invention to provide a Y-wrench for engagement with spokes of wheels of various sizes.

According to the present invention, a Y-wrench is provided for a wheel with several spokes. The Y-wrench includes a handle, a first prong extending from the handle, a second prong pivotally connected with the handle, a first rod connected with the first prong and a second rod connected with the second prong. In operation, the first rod is engaged with one of the spokes and the second rod is engaged with another one of the spokes. Thus, the wheel is kept in position with the Y-wrench.

A spring may be provided between the first prong and the second prong.

Other objects, advantages, and novel features of the invention will become more apparent from the following detailed description when taken in conjunction with the attached drawings.

### BRIEF DESCRIPTION OF THE DRAWINGS

The present invention will be described through detailed illustration of embodiments referring to the attached drawings wherein:

FIG. 1 is a perspective view of a Y-wrench according to a first embodiment of the present invention.

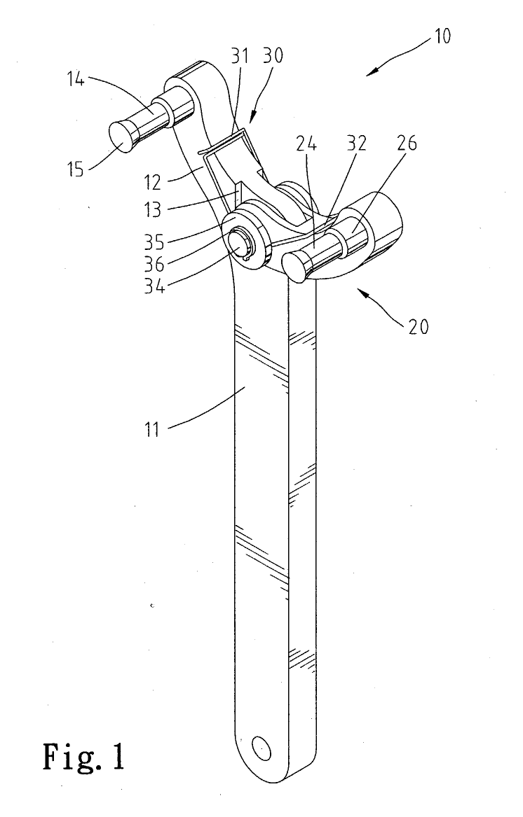

FIG. 2 is an exploded view of the Y-wrench shown in FIG. 1.

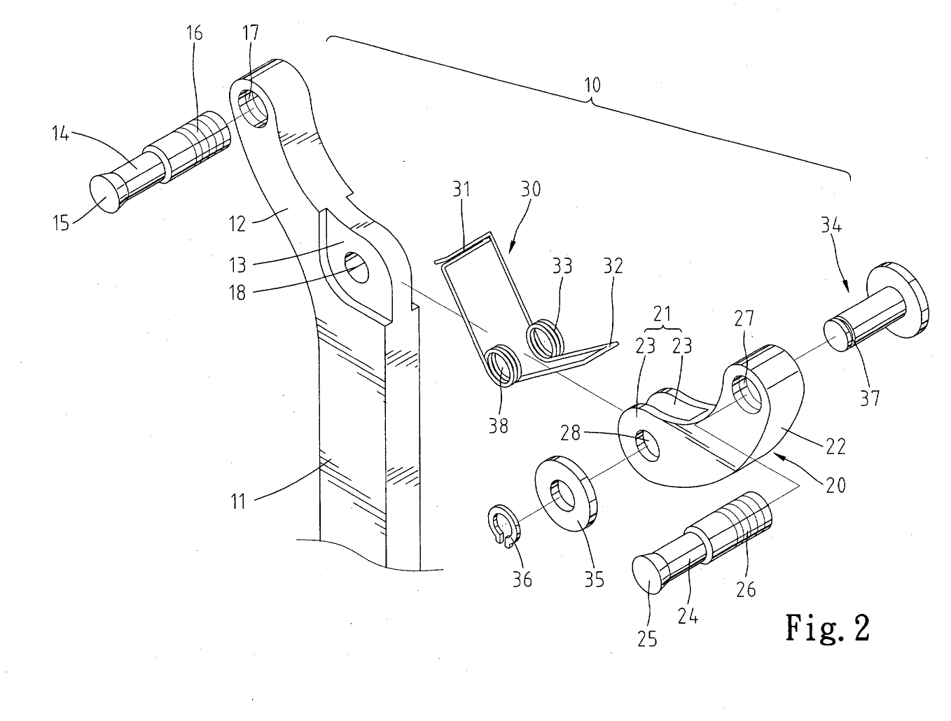

FIG. 3 is a front view of the Y-wrench shown in FIG. 1.

FIG. 4 is a front view of the Y-wrench shown in FIG. 1 in engagement with spokes of a wheel.

FIG. 5 is similar to FIG. 4, but showing the Y-wrench in engagement with spokes of a smaller wheel.

FIG. 6 is a perspective view of a Y-wrench according to a second embodiment of the present invention.

FIG. 7 is a perspective view of a Y-wrench according to a third embodiment of the present invention.

FIG. 8 is a front view of a conventional wrench.

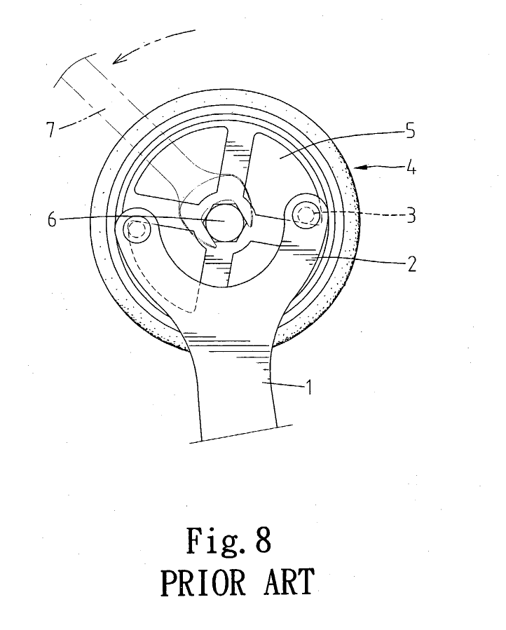

### DETAILED DESCRIPTION OF EMBODIMENTS

Referring to FIGS. 13, according to a first embodiment of the present invention, a Y-wrench 10 includes a handle 11, a first prong 12 extending from the handle 11 and a second prong 20 pivotally connected with the handle 11.

A first rod 14 is connected with the first prong 12. The first rod 14 includes an enlarged end 15 and a threaded end 16. In the first prong 12 is defined a threaded hole 17 for receiving the threaded end 16 of the first rod 14.

A second rod 24 is connected with the second prong 20. The second rod 24 includes an enlarged end 25 and a threaded end 26. In the second prong 20 is defined a threaded hole 27 for receiving the threaded end 26 of the second rod 24.

A connecting portion 13 is formed between the handle 11 and the first prong 12. The connecting portion 13 is of a reduced thickness. A hole 18 is defined in the connecting portion 13.

The second prong 20 includes a first end 21 and a second end 22. Two ears 23 are formed at the first end 21 of the second prong 20. A hole 28 is defined in each of the ears 23.

A spring 30 includes two halves each including a first end 31, a second end 32 and a helical portion 33 defining a hole 38.

In assembly, the connecting portion 13 is located between the ears 23 so that the hole 18 is aligned with the holes 28. The spring 30 is mounted on the first prong 12 and the second prong 20 so that the first end 31 of the spring 30 rests on the first prong 12 and the second end 32 of the spring 30 on the second prong 20 and that the holes 38 are aligned with the holes 28 and 18. A pin 34 is inserted in the holes 38, 28 and 18, thus pivotally connecting the second prong 20 with the handle 11. A washer 35 may be mounted on the pin 34. A C-clip 36 may be put in an annular groove 37 defined in the pin 34.

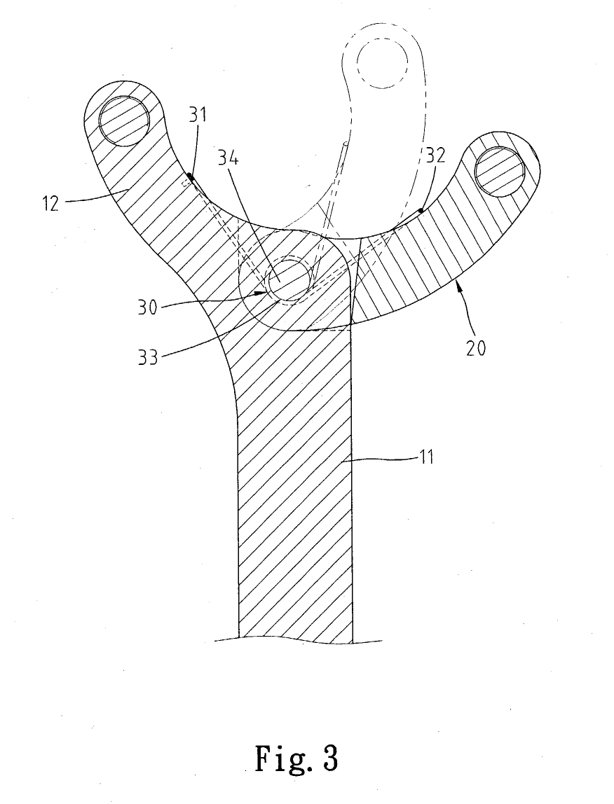

Referring to FIG. 3, the second prong 20 is biased from the first prong 12 by means of the spring 30. However, the second prong 20 can be moved towards the first prong 12 since the second prong 20 is pivotally connected with the first prong 12.

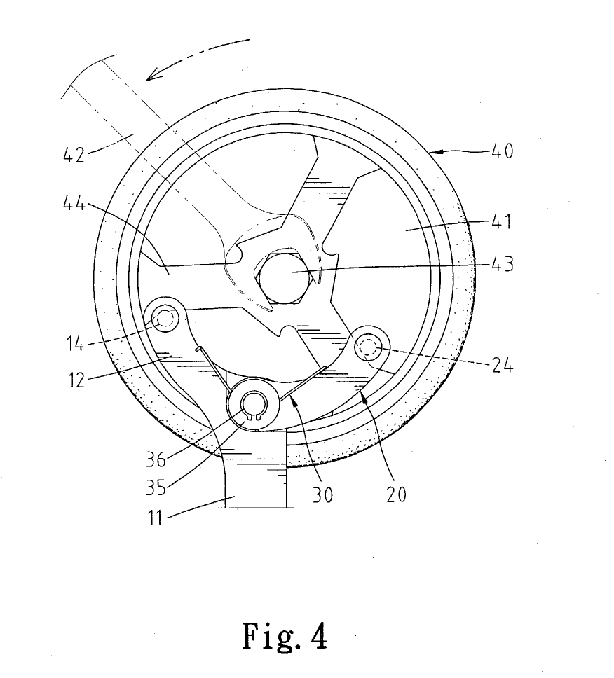

Referring to FIG. 4, the second prong 20 is at a first distance from the first prong 12 so that the Y-wrench 10 can be used to engage with spokes of a wheel of a first size.

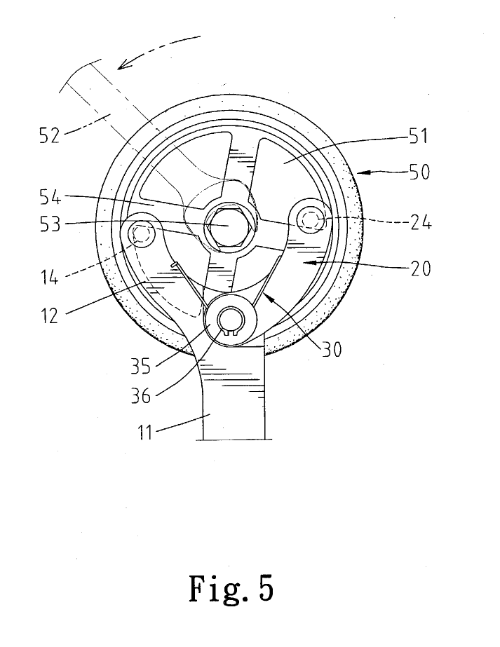

Referring to FIG. 5, the second prong 20 is at a second distance from the first prong 12 so that the Y-wrench 10 can be used to engage with spokes of a wheel of a second size. The second distance is smaller than the first distance. Accordingly, the second size is smaller than the first size.

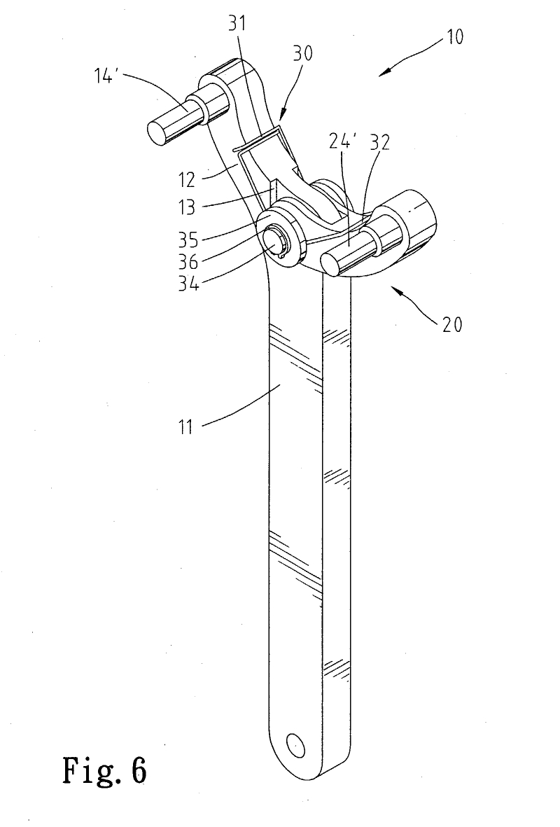

FIG. 6 shows a Y-wrench according to a second embodiment of the present invention. The second embodiment is different from the first embodiment in using two rods 14′ and 24′ instead of the rods 14 and 24. The rod 14′ does not include the enlarged head 15. The rod 24′ does not include the enlarged head 25.

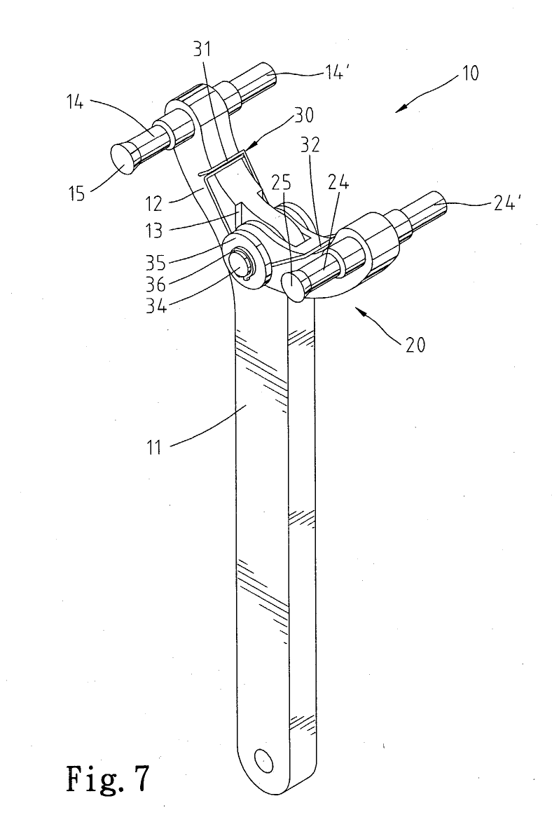

FIG. 7 shows a Y-wrench according to a third embodiment of the present invention. The third embodiment is different from the first and second embodiments in that the first rod 14 of the first embodiment and the first rod 14′ of the second embodiment are both secured to the first prong 12 and that the second rod 24 of the first embodiment and the second rod 24′ of the second embodiment are both secured to the second prong 20.

The present invention has been described through detailed illustration of some embodiments. Those skilled in the art can derive variations from the embodiments without departing from the scope of the present invention. Hence, the embodiments shall not limit the scope of the present invention defined in the claims.

What is claimed is:

1. A Y-wrench includes:
a handle;
a first prong extending from the handle;
a second prong pivotally connected with the handle;
a first rod connected with the first prong; and
a second rod connected with the second prong:

2. The Y-wrench according to claim 1 wherein the first rod includes an enlarged end.

3. The Y-wrench according to claim 1 wherein the first rod includes a threaded end, and the first prong defines a threaded hole for receiving the threaded end of the first rod.

4. The Y-wrench according to claim 1 wherein the second rod includes an enlarged end.

5. The Y-wrench according to claim 1 wherein the second rod includes a threaded end, and the second prong defines a threaded hole for receiving the threaded end of the second rod.

6. The Y-wrench according to claim 1 including a pin inserted in a hole defined in the handle and a hole defined in the second prong.

7. The Y-wrench according to claim 6 including a C-clip put in an annular groove defined in the pin.

8. The Y-wrench according to claim 1 including a connecting portion formed between the handle and the first prong for pivotal connection with the second prong.

9. The Y-wrench according to claim 8 wherein the second prong includes two ears formed there on for sandwiching the connecting portion.

10. The Y-wrench according to claim 9 wherein the connecting portion includes a reduced thickness so that the ears are flush with the handle and the first prong.

11. The Y-wrench according to claim 9 including a pin inserted in a hole defined in each of the ears and a hole defined in the connection portion.

12. The Y-wrench according to claim 1 wherein the A spring includes two halves each including a first end, a second end and a helical portion defining a hole.

13. The Y-wrench according to claim 1 including a spring located between the first prong and the second prong.

14. The Y-wrench according to claim 13 wherein the spring includes a first end in contact with the first prong and a second end in contact with the second prong.

15. The Y-wrench according to claim 13 wherein the spring is a torque spring.

16. The Y-wrench according to claim 15 wherein the spring includes a helical middle portion, a first end in contact with the first prong and a second end in contact with the second prong.

17. The Y-wrench according to claim 16 including a pin inserted in a hole defined in the helical middle portion of the spring and a hole defined in the handle.

18. The Y-wrench according to claim 17 including a C-clip put in an annular groove defined in the pin.
